(19) United States
(12) Patent Application Publication
(10) Pub. No.: US 2023/0269528 A1
(43) Pub. Date: Aug. 24, 2023

(54) AUDIO LOUDSPEAKER ARRAY WITH WAVEGUIDE

(71) Applicant: Endow Audio, LLC, Georgetown, KY (US)

(72) Inventor: David T. Strunk, Georgetown, KY (US)

(21) Appl. No.: 18/111,736

(22) Filed: Feb. 20, 2023

Related U.S. Application Data
(60) Provisional application No. 63/311,522, filed on Feb. 18, 2022.

(51) Int. Cl. H04R 1/40; H04R 1/34; H04R 1/30

(52) U.S. Cl. CPC H04R 1/403; H04R 1/345; H04R 1/30

(57) ABSTRACT

An audio speaker for projecting sound into a listening space along an on-axis and off-axis includes a frame supporting drivers arrayed in a plane for projecting sound off-axis, and a waveguide attached to the frame and supporting an inner driver for projecting sound on-axis. The waveguide at least partially defines a chamber for loading the at least two drivers and the plane is substantially perpendicular to the on-axis. Another audio speaker for projecting sound into a listening space along an on-axis and off-axis includes a three-dimensionally printed unibody supporting at least two drivers arrayed in a plane for projecting sound off-axis. Still another audio speaker includes a frame supporting one group of drivers arrayed in a plane for projecting sound off-axis and a waveguide supported by the frame such that the waveguide extends in an on-axis direction and includes a front portion having an uninterrupted exterior surface.

This application claims the benefit of U.S. Provisional Patent Application No. 63/311,522, filed Feb. 18, 2022, the disclosure of which is incorporated herein by reference.

### TECHNICAL FIELD

This document relates generally to high fidelity sound reproduction arts, and more specifically to a high fidelity sound reproduction system and audio loudspeaker array designed to improve the fidelity, or exactness, of the reproduced sound such that a plurality of listeners in a room each perceive they are listening in a listening sweet spot.

### BACKGROUND

High fidelity sound reproduction or a high fidelity experience is particularly desirable for audiophiles listening to a recording. In the case of listening to a recording by a few individuals, it has traditionally been acceptable to have a listening sweet spot in a listening space wherein imaging of the sound is particularly vivid. The sweet spot is typically the size of a single chair positioned directly in front of a high-end audio speaker, i.e., on-axis, where the music is accurately reproduced for the listener. The term on-axis is defined herein as an axis extending through a geometric center of an array of loudspeakers and substantially perpendicular to a plane containing the array of loudspeakers. In the case of many listeners in a room, however, not all of the listeners can occupy the on-axis sweet spot. As a result, off-axis imaging increases in importance. While good on-axis performance is the norm in high end audio speakers, such off-axis performance is difficult to achieve with known speaker arrays.

A key element of audio loudspeakers is the transducer, commonly called a driver, which is a device whose movement causes changes in sound pressure that reproduces the desired music or sound. Typical transducers used in high fidelity loudspeakers are illustrated in Table 1.

TABLE 1

| Transducer | Typical Frequency | |
|---|---|---|
| Type | Range | Size and Cost |
| Piston Driver | Low (sub), mid, | Moderate size and low cost in |
| | and high | mid frequency range. Subwoofer |
| | | drivers can be large and |
| | | expensive |
| Compression | Mid and High | Typically, small and moderate |
| Driver | (tweeter) | cost |
| Planar/Ribbon | High, down to mid | Large and expensive for both |
| | | mid & high frequencies. |
| | | Smaller and less expensive for |
| | | high frequencies only. |
| Electrostatic | Mid and High | Most expensive transducer. |
| | | Can be extended down to low |
| | | frequency with considerable |
| | | size and cost. |

As is known in the art, a typical driver has a voice coil and magnet, which act together when an electrical signal is applied to make a cone, or diaphragm, move back and forth causing sound pressure or sonic waves. The voice coil and magnet may be referred to collectively as a motor assembly. Each of these noted components is typically supported by a basket. The driver has two faces. A front or radiating face is typically open to the listening space and serves the purpose of radiating sound waves to a listener's ear. This configuration is referred to throughout the specification as forward facing. A back face is typically enclosed by an air space chamber in order to obtain a desired frequency response. The motor assembly is located on the backside of the driver. The common phrase used to describe the function of the air space chamber is that it loads the driver. In other words, the air space chamber is a loading chamber. In an alternative configuration, the driver may be supported such that the back face opens to the listening space radiating sound waves to the listener's ear. This configuration is referred to throughout the specification as rearward facing.

The loading chamber can be either sealed or ported, horn/scoop loaded, or loaded in a transmission line. When sealed, the back face does not directly contribute to the sound waves heard by the listener in the forward facing configuration. When ported, air mass in the port or mass in a drone cone resonates with the driver at a specific frequency. When loaded in a transmission line or horn, low frequency sound waves are typically allowed to escape the loading chamber into the listening space through an opening in the loading chamber, often at a lower frequency than the sound waves transmitted to the listener directly from the front of the source. Since ports produce sound waves at lower frequencies and with unique coloration, i.e., addition of tones or alteration of original tones, ports are considered to be a separate sound source. Together, the driver and its loading chamber are called a loudspeaker.

Conventional audio loudspeaker designs attempt to achieve high fidelity sound reproduction through one of two approaches: (1) utilization of a combination of more than one transducer type or size where each transducer serves a distinct range of frequencies; or (2) utilization of a specialized transducer that is capable of serving an entire range of listening frequencies.

The most common high fidelity audio loudspeaker approach, approach (1), utilizes a combination of more than one transducer type or size. For example, a large piston driver will serve the lowest frequencies (subwoofer) (e.g., typically plays no higher than 80 Hz, but can play up to 250 Hz in certain designs), a smaller piston driver will serve the midrange frequencies, and yet a smaller driver will serve the highest frequencies (tweeter). In some combinations, the tweeter will be a compression driver such as in pro-audio applications where high sound pressure levels (SPL) at low cost is desirable. A typical sound reproduction system in the pro-audio market to cover the entire frequency range may utilize a loudspeaker having a subwoofer ported so that even lower frequencies can be achieved, and may port a midrange driver too to bridge the frequency gap between the subwoofer and the midrange. In such a loudspeaker, the listener has sound coming from five different sound sources over the frequency range from lowest to highest, including: (1) a subwoofer port; (2) a subwoofer; (3) a midrange port; (4) a midrange; and (5) a tweeter.

In a high fidelity sound reproduction system where less emphasis is placed on obtaining high SPL at low cost, and more emphasis is placed on sound quality, one or both ports in the combination described above may be eliminated. Without the subwoofer and midrange ports, the listener has sound coming from only three different sound sources over the frequency range from lowest to highest, including: (1) a subwoofer (2) a midrange; and (3) a tweeter.

Regardless of approach, it is a very difficult task to achieve fidelity high enough across so many different sound sources to recreate an image of a sound stage. Each sound source serves its purpose well in its assigned frequency range, but there is sonic confusion injected by different sound source types over the entire listening range, wherein sonic confusion is a lack of fidelity. Considering that music “notes” are comprised of multiple frequencies including a fundamental frequency and harmonic frequencies, it is often the case that a single musical note could be reproduced over two or three different sound sources in a sound reproduction system with multiple sound sources as described above.

Despite considerable discussion in the literature on how to make SPL nearly constant over a listening range when multiple types of sound sources are used, cost effective approaches to dealing with the sonic confusion created by the inherently different sound generation sources with high fidelity performance are scarce at best.

One variant to using piston or compression drivers for the high frequencies, generally described in the exemplary most common approach above, is the use of a ribbon driver, which claims to have superior sound creation. However, ribbon drivers are incapable of producing frequencies at the lowest end of the frequency range and thus must be paired with another sound source, for example, a piston subwoofer.

One example of the second approach, approach (2), to eliminating the different sound source types or sizes relies on the utilization of a large electrostatic transducer. While such a device can serve all frequency ranges, its high cost and large size limits its use. A smaller and less expensive version utilizes an electrostatic transducer for mid to high frequency ranges but incorporates a piston driver subwoofer to handle the low frequencies. Such a system is still very expensive relative to piston, compression, and even ribbon drivers due to the nature of electrostatic transducers and still requires use of different sound source types.

Yet another example of the second approach is a specialized piston driver. Due to the specifications that the single piston driver must satisfy, including serving all frequency ranges, it is very expensive, sometimes costing more than a complete system of different drive types.

Whether utilizing approach (1) with multiple transducer types or sizes, or approach (2) with a single transducer to achieve high fidelity sound reproduction, the high fidelity speaker industry has adopted a flat surface theory which predominantly teaches that a flat surface is the best means of achieving high fidelity. In fact, the touted advantage of the ribbon transducer and the electrostatic transducer is that they are flat, as opposed to the cone shape of a piston driver. The flat surface theory is that a flat transducer produces a coherent sonic waveform. This approach is so indoctrinated into speaker design that even multiple transducer speakers have the transducers positioned in a single plane so as to approximate a flat surface.

Even the pro-audio market has adopted the flat surface theory for improved sonic performance and has economically implemented it with arrays of transducers. As noted above, the need for low cost and high SPL is more important in the pro-audio market than in the high-fidelity market. Therefore, an array of standard transducers is a good method to achieve both relatively high output and low cost.

One such array is a column array wherein a number of transducers are stacked vertically and in the same plane. In other words, each of the transducers is supported at the same angle to a plane in the listening space. The spacing between transducers is minimized so that the effect of comb filtering is minimized; otherwise at high frequencies the output from one transducer in the array will cancel out the output from a second transducer in the array based on the distance from each transducer to a listening position. Column arrays are 1×N wherein 1 is the number of transducer columns and N is the number of transducer rows.

A second type of array is a line array which is often comprised of at least one midrange column(s) and a tweeter column. The number of transducers used in the midrange column may be different than the number in the tweeter column. Again, when used within a line array, the individual line arrays are 1×N. When two midrange columns are used in a line array, a typical configuration is mid-tweeter-mid.

Due to both the need to cover the listening space and the human ear's ability to better discern differences between a horizontal array and a vertical array, pro-audio arrays are predominantly vertical. Vertical array(s) can be sized and aimed to cover an entire listening space (e.g., all of an audience in a given venue). One modification to the flat, vertical line array is a J-array where a lower elevation of the J-array is formed into an arc to better cover the listening space or audience. Often the J-array is formed using modular units of arrays arranged in an arc instead of individual transducers being arranged in an arc. Again, the purpose of the arc shape of the lower elevation is to improve sound dispersion, which means to better cover the listening space or audience with a more consistent SPL. The arc formation does not, however, improve the sound quality for any listener.

Line arrays used in pro-audio applications offer some improved sonic performance relative to a single driver due to the averaging of distortion from many drivers. As a result, distortion from any one driver is masked to the degree that each driver has its own distortion signature and not a common distortion shared with all the other drivers. This improvement in sonic performance, however, is insufficient to meet the imaging requirement necessary for the listener to perceive the recording sounds like a live performance. For live sound imaging, the loudspeaker system should substantially reproduce in three dimensions the location of sound sources. A good live sound imaging system, for example, will sound like a lead singer is closer to the listener than the drummer who is located behind the lead singer.

When an array of radiating drivers is being discussed, it is important to understand whether the drivers are operating in common acoustic phase or in opposing acoustic phase. Acoustic phase is in reference to the polarity of the sound pressure wave radiating into a listening space where the sound is received by a listener and is a combination of both mechanical and electrical phase of the drivers. For the drivers to operate in common acoustic phase, the drivers must face the same way (e.g., forward or rearward facing) and be wired with the same polarity or the drives may face opposite one another and be wired with opposite polarity.

As described above, one limitation of conventional audio speaker array designs is their inability to produce on-axis performance, while providing off-axis performance, similar to that produced by high end audio speakers. Accordingly, a need exists in the loudspeaker industry for a high fidelity audio speaker array capable of on-axis, or single chair sweet spot, performance coupled with off-axis performance that creates the benefit of a whole listening room being the listening sweet spot. The whole room sweet spot is advantageous over the industry common single chair sweet spot because it allows listeners to be mobile and/or participate with other listeners who are sharing the experience. The whole room sweet spot can also be described as perceiving a live performance regardless of position in the listening space.

### SUMMARY OF THE INVENTION

In accordance with the purposes and benefits described herein, an audio speaker is provided for projecting sound into a listening space along an on-axis and off-axis. The audio speaker may be broadly described as including a frame or manifold supporting at least two drivers arrayed in a plane for projecting sound off-axis, and a waveguide attached to the frame and supporting an inner driver for projecting sound in an on-axis direction. In this embodiment, the waveguide at least partially defines an air space chamber for loading the at least two drivers and the plane is substantially perpendicular to the on-axis.

In another possible embodiment, the waveguide extends in a direction substantially perpendicular to the plane and along the on-axis.

In still another possible embodiment, the inner driver is a tweeter.

In yet another possible embodiment, the inner driver is supported by the waveguide in the plane.

In one other possible embodiment, the inner driver is supported by the waveguide at an acoustic center of the at least two drivers arrayed in a plane.

In still yet another possible embodiment, the inner driver is supported by the waveguide between the plane and an output end of the waveguide or at the output end of the waveguide.

In one other possible embodiment, a face of the inner driver is substantially perpendicular to the on-axis.

In yet another possible embodiment, the at least two drivers arrayed in a plane include at least one forward facing driver and at least one rearward facing driver.

In still another possible embodiment, the waveguide includes a front waveguide and a rear waveguide.

In another possible embodiment, the front waveguide extends from the frame in the on-axis direction.

In one additional embodiment, the front waveguide includes an uninterrupted outer surface.

In still another possible embodiment, the waveguide includes an interior surface that functions as a horn for the inner driver.

In yet one other possible embodiment, a length of the waveguide is greater than or equal to one third of a circumference of the frame.

In another possible embodiment, a front waveguide extends in the on-axis direction and includes a round shaped portion adjacent the frame which transitions into an oval shaped portion.

In still yet another possible embodiment, an exterior circumference of the front waveguide increases as the front waveguide transitions from the round shaped portion to the oval shaped portion.

In one other possible embodiment, minor and major axes of an interior surface of a front waveguide increase at different rates as interior surface of the front waveguide transitions from a substantially round surface adjacent the inner driver to a substantially oval surface at an output edge.

In another possible embodiment, a front waveguide extends in the on-axis direction and includes a first portion adjacent the frame having substantially the same outer shape as the frame and a second portion having a different shape.

In still one other possible embodiment, the second portion is oval shaped.

In a different possible embodiment, the first portion includes at least two flat surfaces corresponding with the at least two drivers.

In yet one other possible embodiment, the audio speaker further includes a second driver for projecting sound in an on-axis direction, wherein the inner driver and the second driver are coaxial.

In one other possible embodiment, an audio speaker for projecting sound into a listening space along an on-axis and off-axis includes a three-dimensionally printed unibody supporting at least two drivers arrayed in a plane for projecting sound off-axis.

In another possible embodiment, the audio speaker further includes an inner driver for projecting sound in an on-axis direction.

In yet another possible embodiment, the plane is substantially perpendicular to the on-axis.

In still another possible embodiment, the unibody forms a waveguide for the at least two drivers.

In still one other possible embodiment, the unibody defines an air space chamber for loading the at least two drivers.

In another possible embodiment, the unibody includes a seamless outer surface.

In one more possible embodiment, an audio speaker for projecting sound off-axis into a listening space includes a frame supporting one group of at least two drivers arrayed in a plane for projecting sound off-axis, and a waveguide supported by the frame. In this embodiment, the waveguide extends in an on-axis direction and includes a front portion having an uninterrupted exterior surface.

In another possible embodiment, a length of the front portion of the waveguide is greater than or equal to one third of a circumference of the frame.

In yet another possible embodiment, the front portion of the waveguide includes a round shaped portion adjacent the frame which transitions into an oval shaped portion.

In still another possible embodiment, the audio speaker further includes a unibody including the frame and the waveguide.

In the following description, there are shown and described several embodiments of audio speakers. As it should be realized, the audio speakers are capable of other, different embodiments and their several details are capable of modification in various, obvious aspects all without departing from the audio speakers as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the audio speakers and together with the description serve to explain certain principles thereof. In the drawing figures:

FIG. 1 is a cutaway perspective view of an audio speaker showing a plurality of radially arrayed drivers and an inner driver mounted to a frame including a waveguide;

FIG. 2 is a cutaway plan view of the audio speaker in FIG. 1;

FIG. 3 is a front plan view of the audio speaker in FIG. 1;

FIG. 4 is a section perspective view of the audio speaker in FIG. 1;

FIG. 5 is a perspective view of an audio speaker showing a plurality of radially arrayed drivers mounted to a frame including a waveguide in alternating forward and rearward facing directions;

FIG. 6 is a schematic diagram of nine radially arrayed drivers;

FIG. 7 is a perspective view of a speaker system including the audio speaker in FIG. 1 and a subwoofer/enclosure;

FIG. 8 is a side plan view of an alternate embodiment of an audio speaker showing different front and rear waveguide outer surface shapes;

FIG. 9 is a front plan view of the alternate embodiment illustrating a transition of the shape of the inner surface between the inner driver and front waveguide output edge;

FIG. 10 is a perspective view of the alternate embodiment of FIG. 8;

FIG. 11 is a cutaway perspective view of another alternate embodiment of an audio speaker showing an inner driver mounted to a partially closed output edge of a front waveguide;

FIG. 12 is a cutaway perspective view of another alternate embodiment of an audio speaker with a fully closed output edge of a front waveguide and no inner driver;

FIG. 13 is a cutaway perspective view of another alternate embodiment of an audio speaker illustrating a drivers in an outer group of drivers angled toward a sweet spot (less than ninety degrees) and away from a sweet spot (more than ninety degrees); and

FIG. 14 is a frequency response waterfall chart for the audio speaker in FIG. 1.

Reference will now be made in detail to the present embodiments of the audio speakers, examples of which are illustrated in the accompanying drawing figures, wherein like numerals are used to represent like elements.

### DETAILED DESCRIPTION

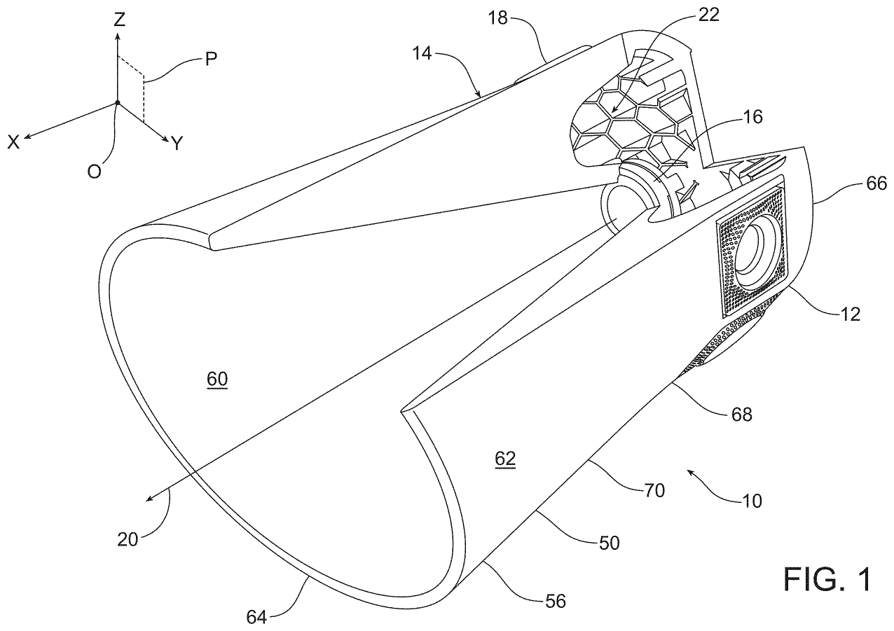

Reference is now made to FIG. 1 which illustrates one embodiment of an audio speaker 10. As shown, the described audio speaker 10, or speaker array, includes a plurality of drivers supported by, or mounted or attached to, a frame 12 for projecting sound along an on-axis and off-axis into a listening space. Also shown is a three dimensional Cartesian coordinate system which generally orients the speaker array 10 relative to X, Y, and Z directions. The coordinate system includes an origin, designated O, and axis lines designated X, Y, and Z and oriented as shown by the arrows. Axis line X generally corresponds with an on-axis direction as illustrated by line 20 in FIG. 1. Axis lines Y and Z generally represent off-axis directions that are perpendicular to the axis line X or on-axis line 20. As shown, axis lines Y and Z define a plane, designated P, which itself is perpendicular to on-axis line 20. Throughout the specification, reference will be made to an on-axis which will generally coincide with the X direction of the coordinate system and an off-axis which will generally coincide with directions other than the on-axis direction including, for example, the Y and/or Z or other directions of the coordinate system.

In the described embodiment, the frame 12 includes a waveguide 14 extending along the on-axis 20 toward a listening space. The frame 12 and waveguide 14 may be integrally formed using 3-dimensional printing, made of a wide variety of materials such as carbon copolymer, and may take many different shapes. In other embodiments, the waveguide 14 may be printed, molded, or otherwise formed apart from the frame 12 and then secured thereto. As shown in FIG. 1, the described frame 12 is ring or disc-shaped with the plurality of drivers mounted or attached thereto. In other embodiments, the frame 12 may take other shapes including, for example, oval or elliptical, or geometric shapes approximating a circle, such as an octagon, or oval, or other geometric shapes such as a square or rectangle.

An interior airspace defined by the frame 12 may be utilized to load at least some of the plurality of drivers. In the described embodiment, however, interior air spaces defined by the frame 12 and the waveguide 14 combine to form a single interior airspace or loading chamber, generally designated reference numeral 22, that is utilized to load at least a portion of the plurality of drivers. The interior air spaces/loading chamber may take any size or shape and may or may not be loaded with an acoustical transducer such as an additional driver. These features are described in more detail below along with additional aspects of the waveguide 14.

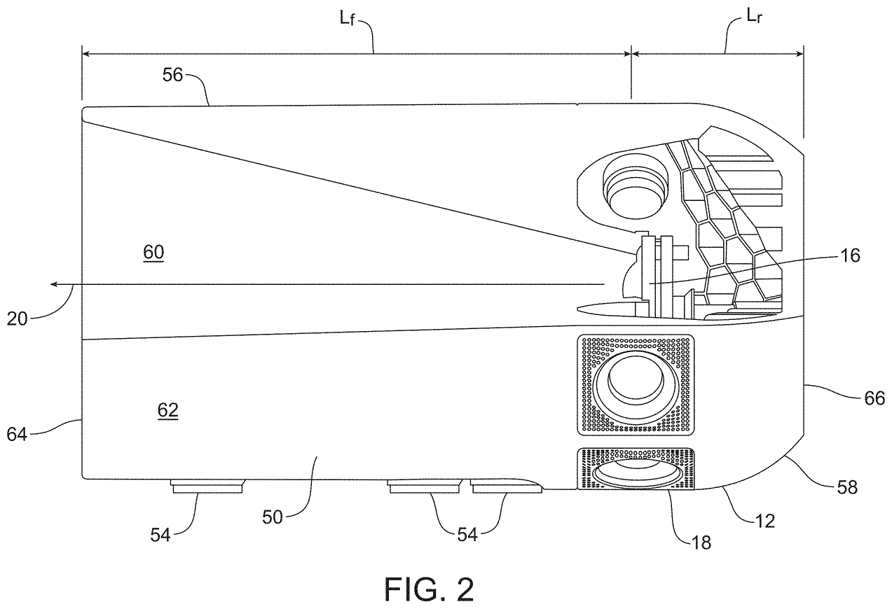

As further shown, the plurality of drivers includes an inner driver 16 and an outer group of drivers 18. The inner driver 16 is a higher frequency driver, for example, a tweeter which typically plays in a frequency range extending to 20 kHz. As suggested above and shown in FIGS. 1 and 2, the inner driver 16 is mounted in a known manner to the frame 12 in a forward facing and generally central manner. In this arrangement, the inner driver 16 primarily contributes sound reproduction along the on-axis 20, i.e., in an on-axis direction. This is due to the inherent directionality of the higher frequencies the inner driver 16 plays. Hence, the inner driver 16 is facing forward and on-axis towards a common single chair sweet spot. This should be the case whether the speaker is mounted such that the on-axis is horizontal or otherwise to provide optimal sound imaging at the sweet spot or listener's ear. If the speaker is sitting on the floor or hanging from a ceiling, for example, the speaker would be mounted such that the on-axis is angled upward or angled downward toward the sweet spot.

The outer group of drivers 18 contribute sound reproduction at frequencies below the inner driver 16 and off-axis. In this embodiment, the outer group of drivers 18 contribute sound reproduction up to and including approximately 6 kHz as this cutoff maintains clear imaging on-axis, with a maximum of 10 kHz. In other words, even if a selected outer group of drivers is capable of playing above the approximately 6 kHz cutoff, a crossover circuit may be utilized to prevent them from doing so because the projection of higher frequencies off-axis or in many directions reduces the clarity of imaging on-axis, which would be diminish product performance. The utilization of such crossover circuits, whether active or passive, located within the speaker, speaker enclosure, or otherwise, is generally known in the art.

In the described embodiment, multiple common drivers are utilized in the outer group of drivers 18 and electrically connected to operate in common acoustic phase. In addition, each of the drivers in the outer group of drivers 18 are the same type and size (e.g., all purchased from the same manufacturer so they will have very similar characteristics) which necessarily minimizes the number of different types of sound sources and improves fidelity. Of course, other embodiments could utilize different drivers and/or drivers not electrically connected to operate in common acoustic phase within the outer group of drivers 18 but at the expense of the improved fidelity. Moreover, in the embodiments described herein, each of the drivers in the outer group of drivers 18 is a piston driver capable of playing a mid or a full frequency range which also lowers cost.

If the outer group of drivers 18 include full-range drivers, then the outer group of drivers could reproduce high frequencies in addition to the high frequencies produced on-axis by the inner driver 16. If the outer group of drivers 18 include only mid-range drivers, then the outer group of drivers will have a crossover frequency with the inner driver 16 whereby the inner driver would make a primary contribution in sound reproduction above the crossover frequency. It should be noted that still other embodiments may not include an inner driver. In such embodiments, the plurality of drivers includes only the outer group of drivers 18.

Depending on a diameter of the mid- or full-range drivers implemented in the outer group of drivers disclosed herein, the drivers will have an ability to play down to a certain frequency. The larger the diameter of the driver, the lower frequency it can play. The tradeoff with larger drivers, however, is their difficulty in playing higher frequencies. In the described embodiments, the drivers in the outer group of drivers 18 of the speaker arrays are selected to be generally within a ½″ diameter to a 4″ diameter range. For the most demanding high-fidelity applications where the speaker array is utilizing drivers in the ½″ to 4″ diameter range playing all the way to the top of the human listening range of 20,000 Hz, it is typical for the speaker array to play down to 100 Hz. If frequencies lower than 100 Hz are required or preferred, then a woofer or subwoofer may be added, as described below, to a system to play from 100 Hz down to whatever frequency the listener desired, for example, 20 Hz.

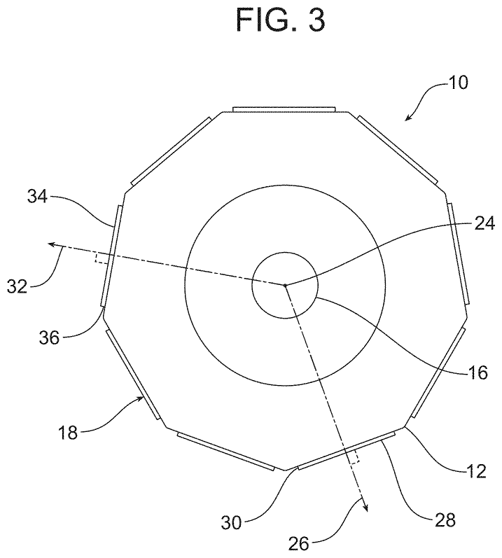

The inner driver 16 is located at an acoustic center 24 of the outer group of drivers 18, as shown in FIGS. 1 and 2, in order to optimize time coherency in the listening space. As perhaps best illustrated in FIG. 3, the acoustic center 24 is approximately a geometric center of the outer group of drivers 18. If a first line 26 is drawn generally perpendicularly through a face 28 of a first driver 30 and a second line 32 is drawn generally perpendicularly through a face 34 of a second driver 36 in the outer group of drivers 18, then the first and second lines from the drivers in the outer group of drivers will converge essentially at the acoustic or geometric center 24 as shown. While locating the inner driver 16 at the acoustic center 24 optimizes time coherency, the inner driver may be located at varying locations in other embodiments, including locations off of the on-axis, whether within the outer group of drivers or otherwise, and/or translated along the on-axis within, partially within, or without the outer group of drivers but all at the expense of the improved fidelity.

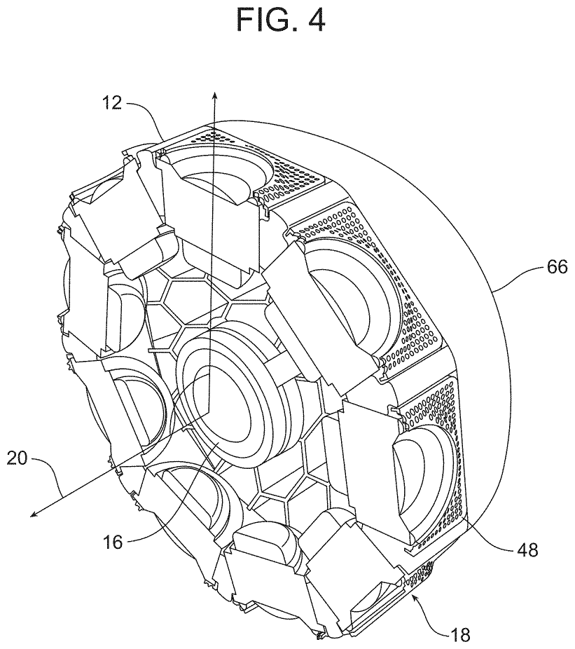

In addition, the nine drivers that form the outer group of drivers 18 are radially arrayed in plane P, as shown in FIG. 4, which is substantially perpendicular to the axis line X or the on-axis 20 as shown in FIG. 1. In other words, the outer group of drivers 18 are mounted to the frame 12 in a ring or circular configuration surrounding the inner driver 16. In this arrangement, the nine drivers are sufficient in number to provide an endless array of sound without boundary artifacts where the array ends and begins. The utilization of nine drivers also provides for excellent listening space coverage and a simple and advantageous wiring configuration described below. Of course, other embodiments may use more or fewer drivers in the outer group of drivers and the inner driver may include more than one driver as well.

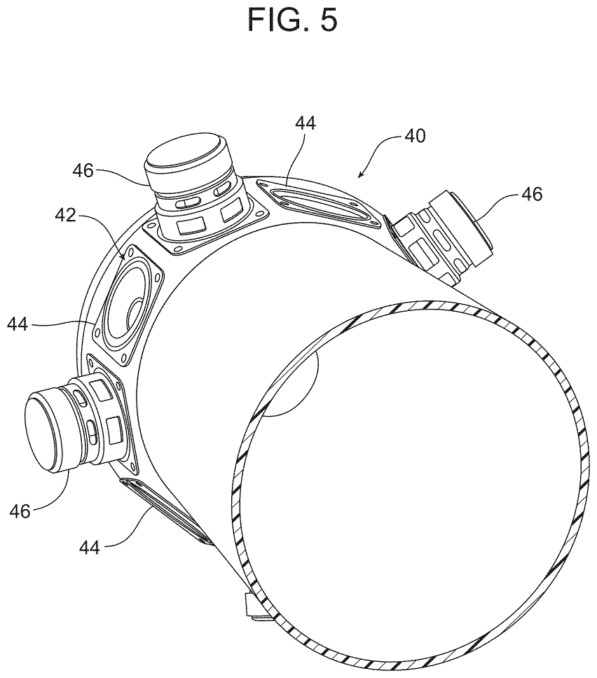

A similar embodiment of a speaker array 40 is shown in FIG. 5. In this embodiment, the speaker array 40 is the same as the speaker array 10 except the nine drivers in the outer group of drivers 42 include five forward facing drivers 44 and four rearward facing drivers 46 in order to attain optimal angles for radiating sonic waves into the listening space. In the described embodiment, the drivers alternate between forward and rearward facing along the ring or circle as shown.

Such arrangements, including alternating arrangements, are contrary to conventional design philosophy, however, which teaches that a front of mid and high frequency piston drivers must face the listening space or be forward facing as described above. This conventional thinking is due to a valid understanding that sound waves become increasingly directional with increasing frequency and therefore positioning the motor assembly of the driver on a front side of the speaker, i.e., the side that radiates sound waves into the listening space, would redirect the sound waves from direct radiation into the listening space. At lower frequencies, however, sound wave travel becomes omnidirectional such that a motor assembly of one driver blocking a direct path of sound from its cone to the listener is relatively insignificant and thus less of a concern.

Whether the outer drivers are forward facing or alternating, an arrangement of a sufficient number of drivers around the frame provides for an endless array of sound without boundary artifacts where the array ends and begins. The utilization of nine drivers provides for excellent listening space coverage and a simple and advantageous wiring configuration. Of course, other embodiments may use more or fewer drivers in the outer group of drivers and the inner driver may include more than one driver as well.

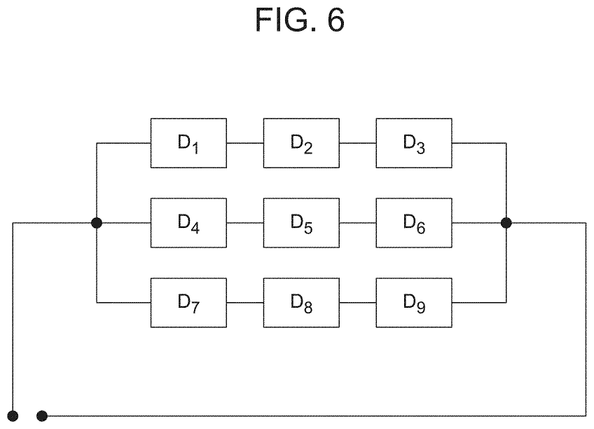

As shown in FIG. 6, the nine drivers (labeled D1-D9) are electrically connected such that a first group, including D1, D2, and D3, a second group, including D4, D5, and D6, and a third group, including D7, D8, and D9, each have three drivers connected in series and each of the first, second, and third groups are themselves electrically connected in parallel. This configuration results in an overall impedance being generally the same as that of an individual driver. Hence, if typical 8-ohm drivers are selected for the outer group of drivers, then the overall impedance of the outer group of drivers would be 8 ohms, which is very amplifier friendly. Of course, other electrical connections may be utilized.

As noted above, the outer group of drivers can be comprised of any number of drivers, but three is the smallest practical quantity to allow excellent entire room imaging, i.e., on-axis performance coupled with off-axis performance that creates the benefit of a whole listening room being the listening sweet spot. Further, at least two, if not all, of the drivers of the outer group of drivers are supported by the frame at a unique angle relative to a plane in the listening space in order to maximize room sweet spot imaging. In other words, at least two drivers of the outer group of drivers should not face in the same direction.

As best shown in FIG. 4, the drivers 48 in the outer group of drivers 18 can be oriented over a wide range of angles relative to the on-axis inner driver 16. This is because the outer group of drivers 18 are contributing frequencies lower than the inner driver 16 and those frequencies tend to be much less directional. In other words, an on-axis listener will adequately hear the low and mid-range or sub-tweeter frequencies played by the outer group of drivers 18 even though they do not face towards the on-axis listener. Hence, depending on particular parameters of the outer group of drivers 18 and the inner driver 16, the outer group of drivers are optimized at ninety degrees from on-axis.

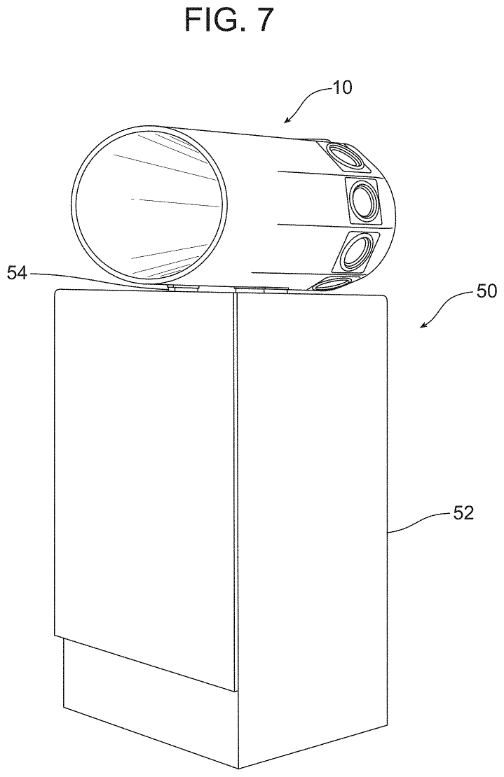

As noted above, a speaker array 10 may form part of an overall speaker system 50 as is known in the art. If frequencies lower than 100 Hz are required or preferred, then a woofer or subwoofer may be added. Such a configuration is shown in FIG. 7, where a complete speaker system 50 includes the speaker array 10 supported by a conventional cabinet or enclosure 52 which houses a 7″ woofer (not shown). In the described embodiment, a plurality of feet 54 (best shown in FIG. 2) support/attach the speaker array 10 to the subwoofer enclosure 52. Generally, the woofer reproduces sound in the 300 Hz and below range, whereas the speaker array 10 reproduces sound above 300 Hz, with the outer drivers 18 covering from 300 Hz to 6 kHz, and the inner driver 16 covering from 6 kHz to 20 KHz. The low frequencies reproduced by the woofer, and a radiator in some embodiments, tend to cover the entire room due to the nature of travel of their relatively long wave lengths; therefore, a conventional speaker provides good room coverage for frequencies typically reproduced by a woofer without special design consideration.

The difficulty in providing good whole listening room coverage is caused by the frequency range reproduced by the midrange. The described speaker system 50 has excellent frequency response in order to meet the objectives of clear imaging on-axis and a pleasing listening experience in the entire listening room. The on-axis frequency response is flat up to 20 kHz, where on-axis is considered to have a range of +/−ten degrees from a direction the inner driver 16 faces. The off-axis frequency response is flat up to the desired 6 kHz, even up to ninety degrees from on-axis. Such a graph is not shown in typical speaker performance discussions, as it has been heretofore assumed to be impractical. When listening to the speaker system 50, however, this amazing measured performance is confirmed to have met its objectives.

Returning to FIGS. 1 and 2, the frame 12 and waveguide 14 provide a common structural member to which the inner driver 16 and outer drivers 18 are mounted. In the described embodiment, the frame 12 and waveguide 14 are three-dimensionally printed as a unibody. While the term unibody is generally known to reference a single molded unit associated with automobiles, the term is used herein to describe a single, three-dimensionally printed unit forming both the frame 12 and the waveguide 14. In such an embodiment, the exterior surfaces of the unibody are seamless or uninterrupted throughout transition from frame 12 to waveguide 14. In such an embodiment, the unibody is a carbon copolymer. Of course, similar polymers and other known printable materials may be utilized. In non-printed embodiments, the frame 12 and waveguide 14 may be made of a wide range of materials and in varying shapes as is generally known in the art.

As shown, the waveguide 14 includes an oval-shaped front waveguide 56 that extends from frame 12 in the on-axis direction toward the listening space. A rear waveguide 58 also extends in the on-axis direction but in a generally opposite direction, as shown. An interior surface 60 of the front waveguide 56 functions as a horn for the purpose of enhancing performance of the inner driver 16. Similarly, an exterior surface 62 of the front waveguide 56 provides a similar enhancing or tuning function but for the outer group of drivers 18. In other words, the shape of the exterior surface 62 of the waveguide 14 functions to enhance the performance of the outer group of drivers 18: particularly, their on-axis performance. In addition, the exterior surface 62 of the front waveguide 56 is continuous and/or uninterrupted. In other words, there are no apertures formed in the exterior surface, for example, for mounting additional drivers, which could adversely affect its function.

Since the outer group of drivers 18 face substantially perpendicular to the on-axis 20, frequencies played by the drivers are not expected to be properly reproduced on-axis. As such, a shape of the exterior surface 62 of the waveguide 14 is important to proper reproduction of midrange frequencies on-axis, in conjunction with the outer group of drivers 18 being in a substantially continuous array—an attribute of a ring or, broadly speaking, a similar shape. Further, as best shown in FIG. 2, a length Lf of the front waveguide 56, as measured from the acoustic center 24 of the outer group of drivers 18 to an output or front waveguide edge 64 of the front waveguide 56, is within a 6″ to 12″ range in the case of an exemplary outer group of drivers 18 having an 18″ circumference. In addition, a length Lᵣ of the rear waveguide 58 is within a 2″ to 3″ range in this embodiment.

The front waveguide 56 length Lf is related to a wavelength of sound frequencies that would otherwise cancel on-axis due to their being emitted from multiple drivers. For example, a frequency that is prone to cancelling when reproduced from an array of outer drivers having an 18″ circumference is 2 kHz, which has a wavelength of 6.8 inches. The general expression is that the length of the front and rear waveguides combined should be greater than or equal to ⅓ of the circumference of the outer group of drivers 18. This is true whether the outer group of drivers 18 are arrayed in a circle, an oval, an ellipse, or another geometric shape such as a square or rectangle. Further, a rear waveguide is not required but is preferred.

In the described embodiment as shown in FIG. 1, an exterior circumference of the front waveguide 56 increases as it extends from a position at or near the frame 12 to the output edge 64. Through trial and error, the described embodiment was determined to provide optimum sound reproduction using an array of outer drivers 18 including nine 1½″ drivers, a front waveguide 14 having a length Lf of 8″, and a rear waveguide 58 having a length Lᵣ of 2.5″. In addition, the front waveguide 56 has an outer circumference of 18″ at the outer group of drivers 18 and an outer circumference of 21.5″ at its output edge 64. As shown in FIG. 1, the outer circumference increases along the length Lf of the front waveguide 56 in a substantially linear or consistent manner. An outer circumference of the rear waveguide 58, on the other hand, may decrease along its length Lᵣ from a position at or near the frame 12 toward a rear edge 66.

Even more and as best shown in FIG. 1, the described front waveguide 56 transitions from a generally round shaped portion 68 adjacent the frame 12, which itself is round, into a generally oval, in this instance elliptical, shaped portion 70. More specifically, the front waveguide 56 gradually flares outwardly from the round shaped portion 68 to the output edge 64 of the oval shaped portion 70 as the front waveguide 56 extends away from the frame 12 in the on-axis direction. Necessarily, the interior surface 60 and the exterior surface 62 similarly transition, albeit in different ways, from generally round surfaces adjacent the frame 12 to generally elliptical surfaces. Even more specifically, minor and major axes increase at varying rates as the interior surface 60 transitions from the generally round surface adjacent the inner driver 16 to the generally elliptical surface at the output edge 64 of the front waveguide 56. Similarly, a circumference of the exterior surface 62 increases as the exterior surface transitions from the generally round surface adjacent the frame 12 to the generally elliptical surface at the output edge 64 of the front waveguide 56.

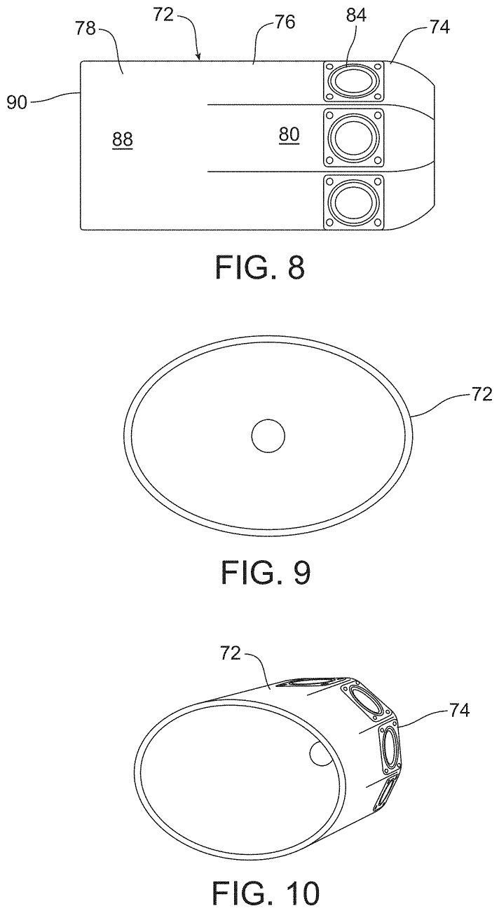

In an alternate embodiment shown in FIGS. 8-10, an exterior surface of a front waveguide 72 may maintain a shape of a frame 74 (or similar thereto) along a first portion 76 of the front waveguide as it extends away from the frame before transitioning into a second portion 78. In such embodiments, the frame shaped or first portion 76 may include flat surfaces 80 which generally corresponding with flat faces of the drivers 84 of the outer group of drivers 86. As best shown in FIGS. 8 and 10, these flat surfaces 80 extend away from the frame 74 in the on-axis direction before gradually transitioning into a generally elliptical surface 88 at an output end 90 of the front waveguide 72. In still other embodiments, an exterior circumference of the front waveguide may remain generally consistent along its length.

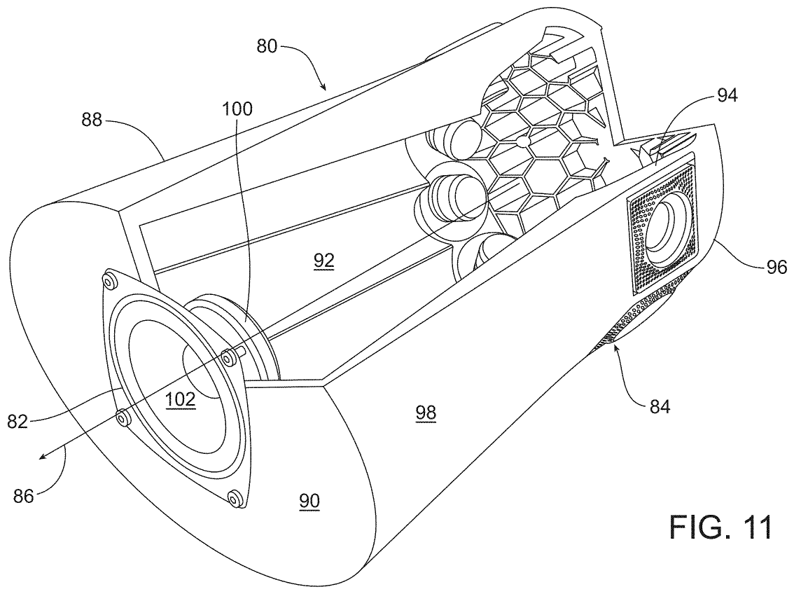

In still another embodiment shown in FIG. 11, a speaker array 80 includes an inner driver 82. The inner driver 82 may produce frequencies other than the higher frequencies in the FIG. 1 embodiment and is located in a position other than the acoustic center of an outer group of drivers 84. In one such alternate embodiment, the inner driver 82 may be a woofer that plays lower frequencies than the drivers in the outer group of drivers 84. As shown, the inner driver 82 is translated toward the listening space along an on-axis 86 and mounted at least partially within a front waveguide 88. More specifically, an output edge 90 of the front waveguide 88 is partially closed and the inner driver 82 is centrally mounted thereto. In other words, the inner driver 82 may be positioned between the acoustic center or the plane encompassing the outer group of drivers 84 and the output end 90 of the waveguide 88, as shown. The result is a compact speaker array 80 that covers a very wide frequency range.

For further space utilization, the air space 92 needed to load the inner driver 82 is fully defined by the front waveguide 88. In other embodiments, the air space 92 may be a combination of air spaces defined by the front waveguide 88, the frame 94, and/or a rear waveguide 96. As in the FIG. 1 embodiment, a shape of an outer surface 98 of the front waveguide 88 is important for optimum performance of the speaker array 80 and the outer group of drivers 84 in the mid frequency range. Accordingly, the shape of the outer surface 98 may take the same forms and may vary in the same manner as the outer surfaces described above and shown in the embodiments in FIGS. 1-10.

In still other embodiments, a coaxial driver, as is known in the art, may be utilized and located in the front waveguide interior. A coaxial driver may include a low frequency driver (e.g., a woofer) 82 and a higher frequency driver (e.g., a tweeter) on the same axis. This embodiment is illustrated using FIG. 11 except the higher frequency driver is not shown as mounting a second, co-axial driver as described herein is generally known in the art. The higher frequency driver would typically be mounted to the low frequency driver 82 either behind a magnet 100 of the low frequency driver, or in front of a cone 102 of the low frequency driver. The low frequency driver 82 receives the lower frequency content, and the higher frequency driver receives the higher frequency content. With such a coaxial driver operating in the interior of the front waveguide 88—along with the outer group of drivers 84 receiving mid frequency content, the speaker array 80 would have very high on-axis imaging performance, and a very pleasing off-axis performance, all in a compact package.

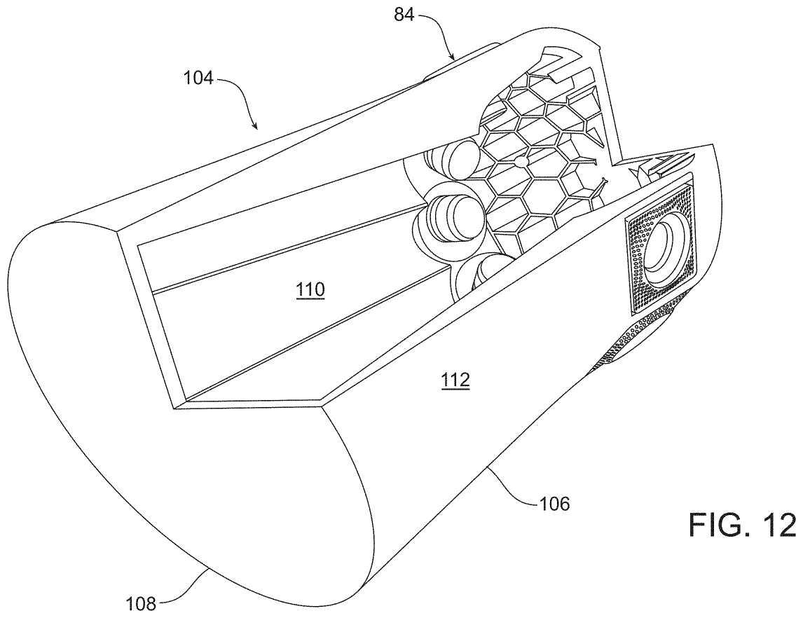

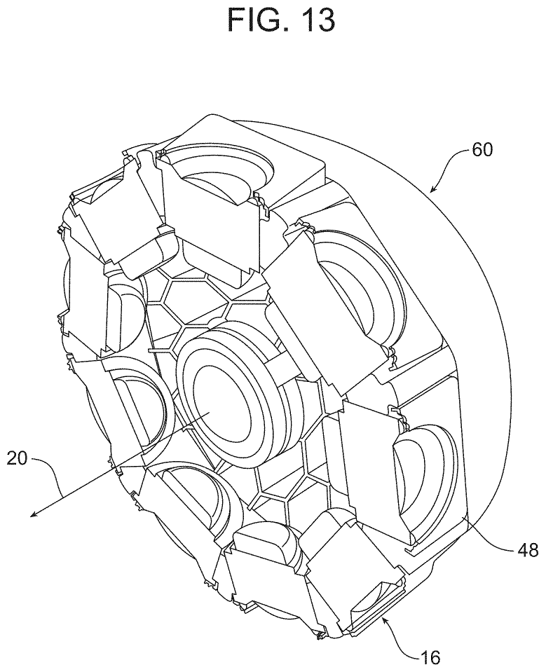

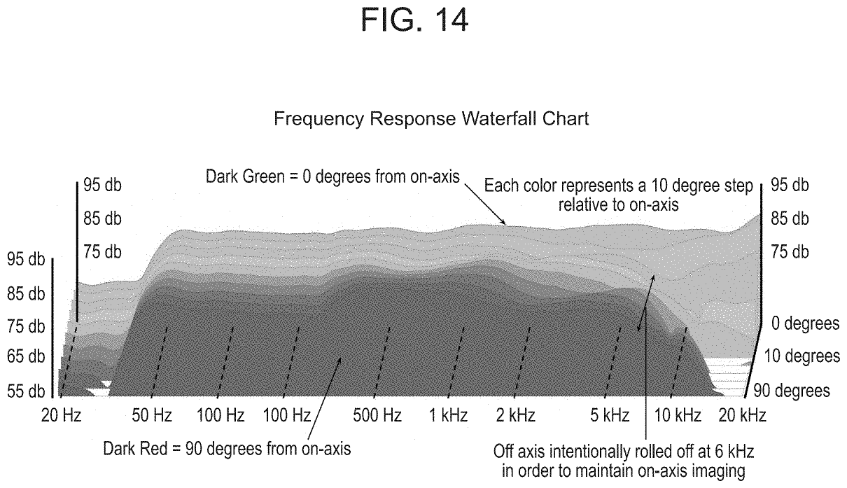

In yet other embodiments, as shown in speaker array 104 in FIG. 12, an inner driver used in the embodiments described above is removed from the speaker arrays. In other words, there is no inner driver. Otherwise, the speaker array 104 is generally the same as the speaker array 10 except a front waveguide 106 includes a closed end 108. Since the speaker array 104 does not include an inner driver, the output edge 64 is not required and the front waveguide can be closed. In the described embodiment, the front waveguide 106 and a closed end 108 combine to define at least a portion of a loading chamber 110 for the outer group of drivers 84.

Again, as in the FIG. 1 embodiment, a shape of an outer surface 112 of the front waveguide 106 is important for optimum performance of the speaker array 104, namely, the outer group of drivers 84 in the mid frequency range. Accordingly, the shape of the outer surface 112 may take the same forms and may vary in the same manner as the outer surfaces described above and shown in the embodiments in FIGS. 1-10 albeit with a closed end 108.

The foregoing has been presented for purposes of illustration and description. It is not intended to be exhaustive or to limit the embodiments to the precise form disclosed. Obvious modifications and variations are possible in light of the above teachings. For instance, outer drivers forming the outer group of drivers may be woofers or tweeters, not just midrange drivers as illustrated herein. Further, a woofer and/or tweeter could be located in a rear waveguide in symmetry with a front waveguide. Alternately, a woofer and/or tweeter could be located in a rear waveguide independent of what is located in a front waveguide. Further still, an outer group of drivers may not have every driver position filled. For example, a given array circumference may allow for nine driver positions, but only eight of those positions are filled for a variety of reasons—such as optimizing the impedance of the array of outer drivers or avoiding a location where a driver's output is blocked by a mounting mechanism. The portion of the array circumference that is not utilized with a driver can be in a single location (driver position is skipped), or spread in some fashion between the array positions that are populated with drivers. Even more, a speaker system can have multiple outer groups of drivers, either integrated side-by-side and sharing the same waveguides, or separate with their own waveguides.

In one further embodiment, the outer group of drivers may be mounted greater than or less than ninety degrees from on-axis. In the first described embodiment, each of the drivers 48 in the outer group of drivers 16 face substantially at ninety degrees relative to the waveguide or on-axis 20. This is best illustrated in FIG. 3 where lines 26 and 32 extend from an acoustic center 24 (through which the on-axis 20 extends out of the page) perpendicularly through driver faces 28, and 34. As shown in FIG. 13, a first driver 114 in the outer group of drivers 16 is angled toward a sweet spot (less than ninety degrees) and a second driver 116 in the outer group of drivers is angled away from the sweet spot (more than ninety degrees). The drivers 48 may be alternating toward and away, all toward, or all away from the sweet spot in different embodiments.

All such modifications and variations are within the scope of the appended claims when interpreted in accordance with the breadth to which they are fairly, legally and equitably entitled.

What is claimed:

1. An audio speaker for projecting sound into a listening space along an on-axis and off-axis, comprising:
a frame supporting at least two drivers arrayed in a plane for projecting sound off-axis; and
a waveguide attached to the frame and supporting an inner driver for projecting sound in an on-axis direction, wherein the waveguide at least partially defines an air space chamber for loading the at least two drivers and the plane is substantially perpendicular to the on-axis.

2. The audio speaker of claim 1, wherein the waveguide extends in a direction substantially perpendicular to the plane and along the on-axis.

3. The audio speaker of claim 1, wherein the inner driver is a tweeter.

4. The audio speaker of claim 1, wherein the inner driver is supported by the waveguide in the plane.

5. The audio speaker of claim 1, wherein the inner driver is supported by the waveguide at an acoustic center of the at least two drivers arrayed in a plane.

6. The audio speaker of claim 1, wherein the inner driver is supported by the waveguide between the plane and an output end of the waveguide or at the output end of the waveguide.

7. The audio speaker of claim 1, wherein a face of the inner driver is substantially perpendicular to the on-axis.

8. The audio speaker of claim 1, wherein the at least two drivers arrayed in a plane include at least one forward facing driver and at least one rearward facing driver.

9. The audio speaker of claim 1, wherein the waveguide includes a front waveguide and a rear waveguide.

10. The audio speaker of claim 9, wherein the front waveguide extends from the frame in the on-axis direction.

11. The audio speaker of claim 10, wherein the front waveguide includes an uninterrupted outer surface.

12. The audio speaker of claim 1, wherein the waveguide includes an interior surface that functions as a horn for the inner driver.

13. The audio speaker of claim 1, wherein a length of the waveguide is greater than or equal to one third of a circumference of the frame.

14. The audio speaker of claim 1, wherein a front waveguide extends in the on-axis direction and includes a round shaped portion adjacent the frame which transitions into an oval shaped portion.

15. The audio speaker of claim 14, wherein an exterior circumference of the front waveguide increases as the front waveguide transitions from the round shaped portion to the oval shaped portion.

16. The audio speaker of claim 1, wherein minor and major axes of an interior surface of a front waveguide increase at different rates as interior surface of the front waveguide transitions from a substantially round surface adjacent the inner driver to a substantially oval surface at an output edge.

17. The audio speaker of claim 1, wherein a front waveguide extends in the on-axis direction and includes a first portion adjacent the frame having substantially the same outer shape as the frame and a second portion having a different shape.

18. The audio speaker of claim 17, wherein the second portion is oval shaped.

19. The audio speaker of claim 17, wherein the first portion includes at least two flat surfaces corresponding with the at least two drivers.

20. The audio speaker of claim 1, further comprising a second driver for projecting sound in an on-axis direction, wherein the inner driver and the second driver are coaxial.

21. An audio speaker for projecting sound into a listening space along an on-axis and off-axis, comprising:
a three-dimensionally printed unibody supporting at least two drivers arrayed in a plane for projecting sound off-axis.

22. The audio speaker of claim 20, further comprising an inner driver for projecting sound in an on-axis direction.

23. The audio speaker of claim 20, wherein the plane is substantially perpendicular to the on-axis.

24. The audio speaker of claim 20, wherein the unibody forms a waveguide for the at least two drivers.

25. The audio speaker of claim 20, wherein the unibody defines an air space chamber for loading the at least two drivers.

26. The audio speaker of claim 20, wherein the unibody includes a seamless outer surface.

27. An audio speaker for projecting sound off-axis into a listening space, comprising:
a frame supporting one group of at least two drivers arrayed in a plane for projecting sound off-axis; and
a waveguide supported by the frame, wherein the waveguide extends in an on-axis direction and includes a front portion having an uninterrupted exterior surface.

28. The audio speaker of claim 27, wherein a length of the front portion of the waveguide is greater than or equal to one third of a circumference of the frame.

29. The audio speaker of claim 27, wherein the front portion of the waveguide includes a round shaped portion adjacent the frame which transitions into an oval shaped portion.

30. The audio speaker of claim 27, further comprising a unibody including the frame and the waveguide.
